(19) United States
(12) Patent Application Publication
(10) Pub. No.: US 2015/0360523 A1
(43) Pub. Date: Dec. 17, 2015

(54) SYSTEM AND METHOD FOR DETECTING FLAT TIRE WHEN SMARTPHONE IS IN VEHICLE

(71) Applicants: Sascha Simon, Warwick, NY (US); Zvi Huber, Great Falls, VA (US)

(72) Inventors: Sascha Simon, Warwick, NY (US); Zvi Huber, Great Falls, VA (US)

(21) Appl. No.: 14/818,648

(22) Filed: Aug. 5, 2015

Related U.S. Application Data
(63) Continuation-in-part of application No. 14/072,231, filed on Nov. 5, 2013.
Application No. 14/072,231 is a continuation-in-part of application No. 14/095,156, filed on Dec. 3, 2013.
Application No. 14/095,156 is a continuation-in-part of application No. 14/105,744, filed on Dec. 13, 2013, now Pat. No. 8,989,952.
Application No. 14/105,744 is a continuation-in-part of application No. 14/105,934, filed on Dec. 13, 2013.
Application No. 14/105,934 is a continuation-in-part of application No. 14/136,467, filed on Dec. 20, 2013.
Application No. 14/136,467 is a continuation-in-part of application No. 14/664,409, filed on Mar. 20, 2015.
Application No. 14/664,409 is a continuation-in-part of application No. 14/664,424, filed on Mar. 20, 2015.
(60) Provisional application No. 61/740,814, filed on Dec. 21, 2012.
(60) Provisional application No. 61/740,831, filed on Dec. 21, 2012.
(60) Provisional application No. 61/740,851, filed on Dec. 21, 2012.
(60) Provisional application No. 61/745,677, filed on Dec. 24, 2012.
(60) Provisional application No. 61/955,995, filed on Mar. 20, 2014.
(60) Provisional application No. 62/033,284, filed on Aug. 5, 2014.
(60) Provisional application No. 62/033,290, filed on Aug. 5, 2014.

(51) Int. Cl. B60C 23/02

(52) U.S. Cl. CPC B60C 23/02

(57) ABSTRACT

A device is provided for use with a database, having stored therein, a plurality of signatures corresponding to an improper state of a tire, respectively. The device includes a vehicle mode determining component, a parameter detecting, component, an accessing component, a comparing component and a warning component. The vehicle mode determining component determines whether the device is operating in a vehicle mode. The parameter detecting component detects a predetermined parameter associated with the improper state of it tire and generates a parameter signature based on the detected predetermined parameter. The accessing component accesses one of the signatures from the database. The comparing component generates a comparison signal based on a comparison of the parameter signature and one of the signatures. The warning component generates an improper tire signal based on the comparison signal when the vehicle mode determining component determines that the device is operating in the vehicle mode.

The present application claims priority from: U.S. Provisional Application No. 71/740,814 filed Dec. 21, 2012; U.S. Provisional Application No. 71/740,831 filed Dec. 21, 2012; U.S. Provisional Application No. 71/740,851 filed Dec. 21, 2012; and U.S. Provisional Application No. 71/745,677 filed Dec. 24, 2012, U.S. Provisional Application No. 71/955,995 filed Mar. 20, 2014, U.S. Provisional Application No. 62/033,278 filed Aug. 5, 2014, U.S. Provisional Application No. 62/033,284 filed Aug. 5, 2014 and U.S. Provisional Application No. 62/033,290 filed Aug. 5, 2014, the entire disclosures of which are incorporated herein by reference. The present application is a continuation-in-part of U.S. application Ser. No. 14/072,231 filed Nov. 5, 2013, is a continuation-in-part of U.S. application Ser. No. 14/095,156 filed Dec. 3, 2013, is a continuation-in-part of U.S. application Ser. No. 14/105,744 filed Dec. 13, 2013, is as continuation-in-part of U.S. application Ser. No. 14/105,934 filed Dec. 13, 2013, is a continuation-in-part of U.S. application Ser. No. 14/136,467 filed Dec. 20, 2013, is a continuation-in-part of U.S. application Ser. No. 14/664,409 filed Mar. 20, 2015 and is a continuation-in-part of U.S. application Ser. No. 14/664,424 filed Mar. 20, 2015, the entire disclosures of which are incorporated herein by reference.

### BACKGROUND

Flat tires are problems that many drivers eventually have to rectify, whether on the side of the road of a busy street or in a relatively safe driveway. However, to deal with a fiat tire, a person must first be aware of the flat tire.

Sometimes, a flat tire results from a “blow-out,” wherein a tire quickly deflates as a result of a compromised sidewall that may result from a deteriorated sidewall or a sudden impulse, such as from encountering a large pothole. In other cases, a flat tire results from a slow leak, for example from a puncture, which eventually leads to a totally flat tire. While slowly leaking air, the tire pressure will slowly decrease, Wherein it will eventually pass a point that is unacceptably low, which is likely well prior to actually being considered “flat.” In such cases of a low tire pressure from a leak, the tire will be considered to have an improper state not sufficiently inflated. As such, a low pressured tire or totally flat tire will be a tire having an improper state.

Some vehicles have tire pressure sensors that may inform a driver, by way of a dashboard indicator, that a tire is under pressured. However, not all vehicles have such a system. What is needed is a portable system that may detect a tire having an improper state and that may warn of such an improper state of the tire.

### SUMMARY

The present invention provides a system and method to detect an improper state a tire of a vehicle when the device is in a vehicle mode.

Various embodiments described herein are drawn to a device for use with a database, having, stored therein, a. plurality of signatures corresponding to an improper state of a tire, respectively. The device includes a vehicle mode determining component, a parameter detecting component, an accessing component, a comparing component and as warning component. The vehicle mode determining component determines whether the device is operating m a vehicle mode. The parameter detecting component detects a predetermined parameter associated with the improper state of a tire and generates a parameter signature based on the detected predetermined parameter. The accessing component accesses one of the plurality of signatures from the database. The comparing component generates a comparison signal based on a comparison of the parameter signature and one of the plurality of signatures. The warning component generates an improper tire signal based on the comparison signal when the vehicle mode determining component determines that the device is operating in the vehicle mode.

### BRIEF SUMMARY OF THE DRAWINGS

The accompanying drawings, which are incorporated in and form a part of the specification, illustrate an exemplary embodiment of the present invention and, together with the description, serve to explain the principles of the invention. In the drawings:

FIG. 1 illustrates an example method of modifying operation of a communication device in accordance with aspects of the present invention;

FIG, 2 illustrates an example device in accordance with aspects of the present invention;

FIGS. 3A-C illustrate a vehicle experiencing a blow-out;

FIGS. 4A-C illustrate a vehicle experiencing a slow leak;

FIG. 5 illustrates an example method of registering an improper state of a tire in accordance with aspects of the present invention;

FIG. 6 illustrates an example controlling component of the device of FIG. 2;

FIG. 7 illustrates an example parameter-detecting component of the device of FIG. 2;

FIG. 8 illustrates a method for detecting an improper state of a tire when in a registered vehicle while operating in a registered mode in accordance with aspects of the present invention;

FIG. 9 illustrates an example method of generating a signature associated with an improper state of a tire in accordance with aspects of the present invention; and

FIG. 10 illustrates an example method of verifying an improper state of a tire in accordance with aspects of the present invention.

### DETAILED DESCRIPTION

Aspects of the present invention are drawn to a system and method for determining whether a device is in a vehicle by utilizing field properties within and/or near the specific vehicle.

Aspects of the present invention are drawn to detecting an improper state of a tire of a vehicle using, a smartphone.

Aspects of the present invention are drawn to a smartphone automatically providing warning if an improper state of a tire is detected.

As used herein, the term “smartphone” includes cellular and/or satellite radiotelephone(s) with or without a display (text/graphical); Personal Communications System (PCS) terminal(s) that may combine a radiotelephone with data processing, facsimile and/or data communications capabilities: Personal Digital Assistant(s) (PDA) or other devices that can include a radio frequency transceiver and a pager, Internet/Intranet access, Web browser, organizer, calendar and/or a global positioning system (GPS) receiver; and/or conventional laptop (notebook) and/or palmtop (netbook) computer(s), tablet(s), or other appliance(s), which include a radio frequency transceiver. As used herein, the term “smartphone” also includes any other radiating user device that may have time-varying or fixed geographic coordinates and/or may be portable, transportable, wearable, installed in a vehicle (aeronautical, maritime, or land-based) and/or situated and/or configured to operate locally and/or in a distributed fashion over one or more location(s).

In one non-limiting example embodiment, a communication device, e.g., a smartphone: 1) automatically determines whether it is operating in a vehicle mode; 2) automatically determines whether a tire of the vehicle is in an improper state; and 3) automatically provides a warning when it determines that a tire of the vehicle is in an improper state.

In accordance with aspects of the present invention, a communication device may automatically determine whether it is operating in as vehicle mode by any known method.

With respect to the communication device determining; whether a tire of the vehicle is in an improper state, the determination may take the form of detecting parameters associated with an improper state of a tire, generating an improper tire state signature based on the detected parameters associated with the improper state of the tire, and comparing the generated improper tire state signature with previously stored improper tire state signatures.

For purposes of discussion, consider the situation where a person is driving a vehicle and a tire of the vehicle blows out. A communication device in accordance with the present invention may: 1) determine that it. is in the vehicle; 2) determine that the a tire of the vehicle is in an improper state in this case is totally flat; and 3) provide a warning that the tire is in an improper state.

Clearly, in most cases, a driver will know that there was blow-out as a result of loud noise, sudden jarring of the vehicle, and subsequent drastically altered handling of the vehicle. As such, one might argue that there is little need for a warning from a communication device that the tire is in an improper state. However, in accordance with aspects of the present invention, a communication device may warn others of the improper state of the tire. For example, suppose the driver of the vehicle is a young daughter of the owner of the vehicle. In some embodiments, a communication device may warn the owner of the vehicle, and father of the driver, who is not in the vehicle, that the vehicle has a tire with an improper state. In such cases, the concerned father may contact the likely distraught daughter to help rectify the situation.

In another example, consider the situation where a person is driving a vehicle, a tire of the vehicle has a slow leak and the vehicle does not have any system to detect and warn of tires haling low pressure. In this case, unlike the situation of a blow-out discussed above, a driver may not know that there is a slow leak because there is not be any accompanying loud noise, sudden jarring of the vehicle, and subsequent drastically altered handling of the vehicle. A communication device in accordance with the present invention may: 1) determine that it is in the vehicle; 2) determine that the a tire of the vehicle is in an improper state—in this case slowly leaks air until it is below an acceptable pressure threshold; and 3) provide a warning that the tire is in an improper state.

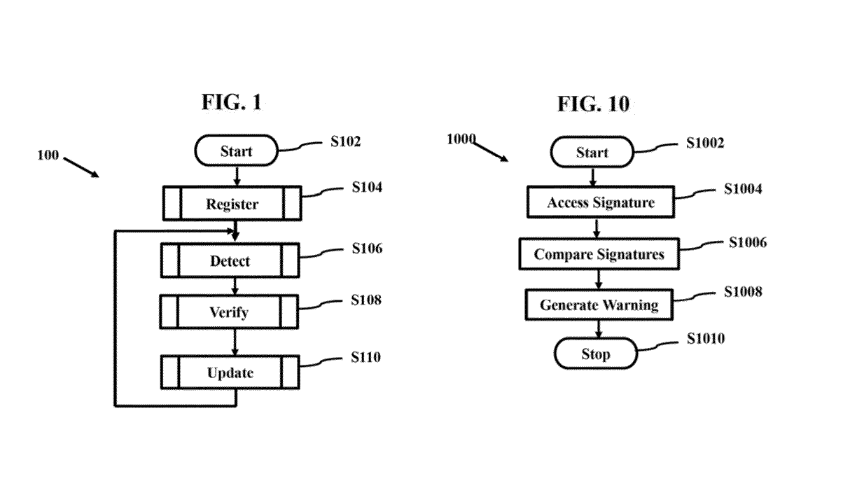

Aspects of the present invention will now be described with reference to FIGS. 1-9,

FIG. 1 illustrates an example method 100 of detecting whether a tire is in an improper state via a communication device in accordance with aspects of the present invention.

Method 100 starts (S102) and a vehicle, a vehicle mode and an improper state of a tire are registered (S104).

As for registration of a vehicle, any known method may be used, a non-limiting example of which is disclosed in for example. U.S. utility patent application Ser. No. 14/072,231 filed Nov. 5, 2013.

As for registration of a vehicle mode, any known method may be used, a non-limiting example of which is disclosed in for example, U.S. utility patent application Ser. No. 14/095,156 filed Dec. 3, 2013.

As for registration of an improper state of a tire, for example, as user may register a blow-out or a slow leak.

A more detailed discussion of registration of a vehicle, a vehicle mode and an improper state of a tire will now be provided with additional reference to FIGS. 2-6.

FIG. 2 illustrates an example device 202 in accordance with aspects or the present invention.

FIG. 2 includes a device 202, a database 204, a field 206 and a network 208. In this example embodiment, device 202 and database 204 are distinct elements. However, in some embodiments, device 202 and database 204 may be a unitary device as indicated by dotted line 210.

Device 202 includes a field-detecting component. 212, an input. component 214, an accessing component 216, a comparing component 218, an identifying component 220, a parameter-detecting component 222, a communication component 224, a verification component 226 and a controlling component 228.

In this example, field-detecting component 212, input component 214, accessing component 216, comparing component 218, identifying component 220, parameter-detecting component 222, communication component 224, verification component 226 and controlling component 228 are illustrated as individual devices. However, in some embodiments, at least two of field-detecting component 212, input component 214, accessing component 216, comparing component 218, identifying component 220, parameter-detecting component 222, communication component 224, verification component 226 and controlling component 228 may be combined as a unitary device. Further, in some embodiments, at least one of field-detecting component 212, input component 214, accessing component 216, comparing component 218, component 220, parameter-detecting component 222, communication component 224, verification component 226 and controlling component 228 may be implemented as a computer having tangible computer-readable media for carrying or having computer-executable instructions or data structures stored thereon. Such tangible computer-readable media can be any available media that can be accessed by a general purpose or special purpose computer. Non-limiting examples of tangible computer-readable media include physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. For information transferred or provided over a network or another communications connection (either hardwired, wireless, or t combination of hardwired or wireless) to a computer, the computer may properly view the connection as a computer-readable medium. Thus, any such connection may be properly termed a computer-readable medium. Combinations of the above should also be included within the scope of computer-readable media.

Controlling component 228 is arranged to communicate with: field-detecting component 212 via a communication line 230; input component 214 via a communication line 232; accessing component 216 via a communication line 234; comparing component 218 via a communication line 236; identifying component 220 via a communication line 238; parameter-detecting component 222 via a communication line 240; communication component 224 via a communication line 242; and verification component 226 via a communication line 244. Controlling component 228 is operable to control each of field-detecting component 212, input component 214, accessing component 216, comparing component 218, identifying component 220, parameter-detecting component 222, communication component 224 and verification component 226.

Field-detecting component 212 is additionally arranged to detect field 206, to communicate with input component 214 via a communication line 246, to communicate with comparing component 218 via a communication line 248 and to communicate with parameter-detecting component 222 via a communication line 245. Field-detecting component 212 may be any known device or system that is operable to detect a field, non-limiting examples of which include an electric field, a magnetic field, and electro-magnetic field and combinations thereof. In some non-limiting example embodiments, field-detecting component 212 may detect the amplitude of a field at an instant of time. In some non-limiting example embodiments, field-detecting component 212 may detect a field vector at an instant of time. In some non-limiting example embodiments, field-detecting component 212 may detect the amplitude of a field as a function over a period of time. In some non-limiting example embodiments, field-detecting component 212 may detect a field vector as a function over a period of time. In some non-limiting example embodiments, field-detecting component 212 may detect a change in the amplitude of a field as a function over a period of time. In some non-limiting example embodiments, field-detecting component 212 may detect a change in a field vector as a function over a period of time. Field-detecting component 212 may output a signal based on the detected field.

Input component 214 is additionally arranged to communicate with database 204 via a communication line 250 and to communicate with verification component 226 via a communication line 252. Input component 214 may be any known device or system that is operable to input data into database 204. Non-limiting examples of input component 214 include a graphic user interface (GUI) having a user interactive touch screen or keypad.

Accessing component 216 is additionally arranged lo communicate with database 204 via a communication line 254 and to communicate with comparing component 218 via a communication line 256. Accessing component 216 may be any known device or system that access data from database 204.

Comparing component 218 is additionally arranged to communicate with identifying component 220 via a communication line 258. Comparing component 218 may be any known device or system that is operable to compare two inputs.

Parameter-detecting component 222 is additionally arranged to communicate with identifying component 222 via a communication line 270. Parameter-detecting component 222 may be any known device or system that is operable to detect a parameter, non-limiting examples of which include velocity, acceleration, angular velocity, angular acceleration, geodetic position, light, sound, temperature, vibrations, pressure, biometrics, contents of surrounding atmosphere, a change in geodetic position, a change in light, a change in sound, a change in temperature, a change in vibrations, a change in pressure, a change in biometrics, a change in contents of surrounding atmosphere and combinations thereof. In some non-limiting example embodiments, parameter-detecting component 222 may detect the amplitude of a parameter at an instant of time. In some non-limiting example embodiments, parameter-detecting component 222 may detect a parameter vector at an instant of time. In some non-limiting example embodiments, parameter-detecting component 222 may detect the amplitude of a parameter as a function over a period of time. In some non-limiting example embodiments, parameter-detecting component 222 may detect a parameter vector as a function over a period of time. In some non-limiting example embodiments, parameter-detecting component 222 may detect a change in the amplitude of as parameter as a function over a period of time. In some non-limiting example embodiments, parameter-detecting component 222 may detect a change in a parameter vector as a function over a period of time.

Communication component 224 is additionally arranged to communicate with network 208 via a communication line 262. Communication component 224 may be any known device or system that is operable to communicate with network 208. Non-limiting examples of communication component include a wired and a wireless transmitter/receiver.

Verification component 226 may be any known device or system that is operable to provide a request for verification. Non-limiting examples of verification component 226 include a graphic user interface having a user interactive touch screen or keypad.

Communication lines 230, 232, 234, 236, 238, 240, 242, 244, 245, 246, 248, 250, 252, 254, 256, 258, 270 and 262 may be any known wired or wireless communication line.

Database 204 may be any known device or system that is operable to receive, store, organize and provide (upon a request) data, wherein the “database” refers to the data itself and supporting data structures. Non-limiting examples of database 204 include a memory hard-drive and a semiconductor memory.

Network 208 may be any known linkage of two or more communication devices. Non-limiting examples of database 208 include a wide-area network, a local-area network and the Internet.

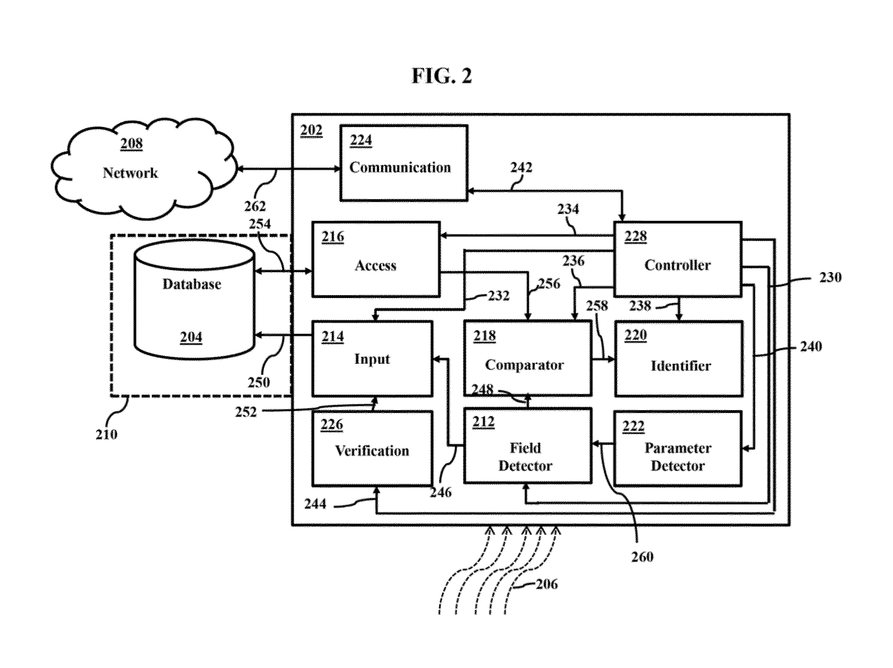

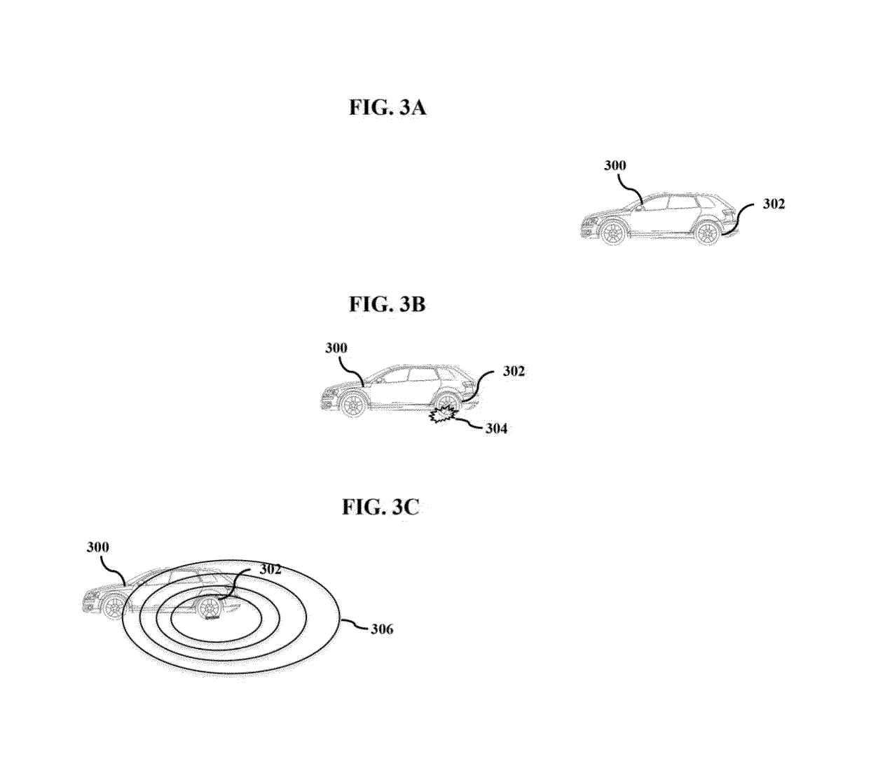

In accordance with aspects of the present. invention, device 202 may detect an improper state of a tire, when it is in a predetermined vehicle and when it is in as vehicle mode. This will be further described with reference to FIGS. 3A-4C.

FIGS. 3A-3C illustrate a vehicle 300 experiencing a blow-out at times t₁, t₂ and t₃, respectively. As shown in FIG. 3A, at time vehicle 300 is driving on a tire 302. As shown in FIG. 3B, at time t₂, tire 302 blows out as indicated by explosion 304. As shown in FIG. 3C, at time t₃ vehicle 300 is driving on tire 302, which is now flat and is making new vibrations and noise as indicated by ovals 306.

Device 202, when in vehicle 300, may detect parameters associated tire 302 blowing out as shown in FIG. 3B. For example, the blow-out may make a sound and may cause a sudden jarring motion of vehicle 300, either of which may be detected by device 202. Device 202 may use any of such detected parameters to create an improper tire state signature, which will be used to determine that tire 302 is actually in an improper state.

Similarly, device 202, when in vehicle 300, may detect parameters associated tire 302 being flat as shown in FIG. 3C. For example, the flat tire may make to particular sound and may cause a particular type of motion of vehicle 300, either of which may be detected by device 202. Device 202 may use any or such detected parameters to create an improper tire state signature, which will be used to determine that tire 302 is actually in an improper state.

There may be instances that device 202 detects parameters that mimic those associated with a tire being in an improper state. For example, vehicle 300 may hit a pothole, generating a sound and jarring motion that mimics a blow-out of a tire similar to that discussed above with reference to FIG. 3B. As such, device 202, when in vehicle 300, may detect parameters associated tire 302 blowing out as shown in FIG. 3B and tire 302 being flat as shown in FIG. 3C to determine that tire 302 is actually in an improper state. By using additional parameters, device 202 would decrease the likelihood of falsely determining that tire 302 is in an improper state.

FIGS. 4A-4C illustrate a vehicle 400 experiencing a slow leak at times t₄, t₅ and t₆, respectively. As shown in FIG. 4A, at time t₄, vehicle 400 is driving on a tire 402. As shown in FIG. 4B, at time t₅, tire 402, which now has a decreased pressure and is making new vibrations and noise as indicated by ovals 404. As shown in FIG. 3C, at time t₆, tire 402, which now has an even more decreased pressure and is making new vibrations and noise as indicated by ovals 406.

Device 202 may detect parameters associated tire 402 having a slow leak as shown in FIGS. 3B-C. For example, the slow leak may cause the road noise to make a particular sound and may cause a particular vibration of vehicle 400, either of which may be detected by device 202. Again, device 202 may use any of such detected parameters to create an improper tire state signature, which will be used to determine that tire 402 is actually in an improper state.

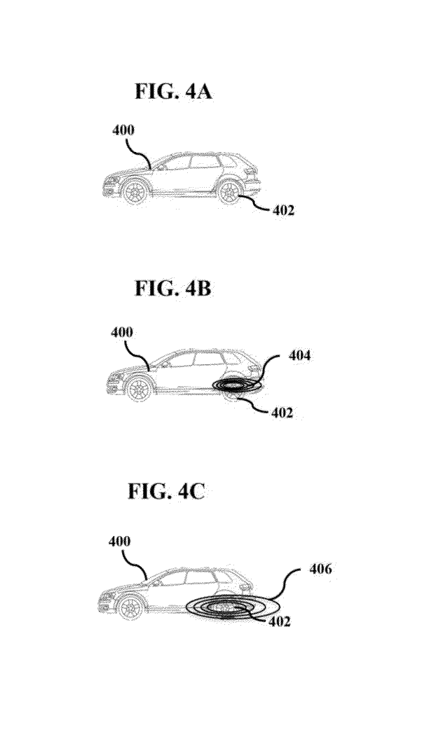

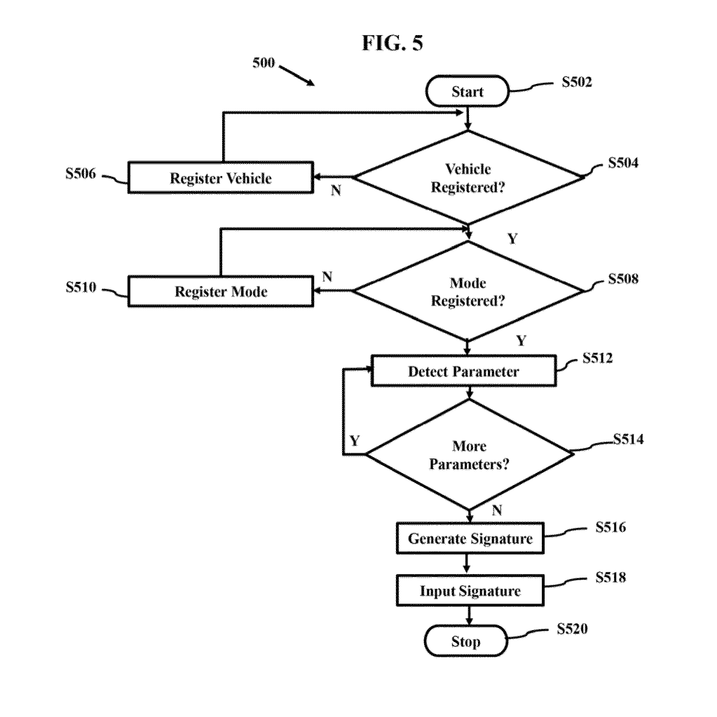

These improper tire state determination and subsequent warning aspects of the present invention will be further described with additional reference to FIGS. 5-6.

For purposes of discussion, consider the following example where a person is driving vehicle 300 of FIGS. 3A-C and is carrying device 202, which is in a vehicle mode.

FIG. 5 illustrates an example method 500 of registering an improper state of a tire in accordance with aspects of the present invention.

As shown in the figure, method 500 starts (S592) and it is determined whether the current vehicle is registered (S504). For example, detected parameters of the current vehicle may be used to generate a vehicle signature associated with the current vehicle. This type of vehicle signature generation may be performed by any known method, a non-limiting example of which is disclosed in U.S. patent application Ser. No. 14/072,231. As shown in FIG. 2, the vehicle signature for the current vehicle may be stored in database 204. Databased 204 may have a plurality of vehicle signatures for a plurality of vehicles, each of which may have been supplied to database 204 as a priori information.

Returning to FIG. 5, if it is determined that the current vehicle is not registered (N at S504), then the vehicle is registered (S506). For example, returning to FIG. 2, controlling component 228 may register the current vehicle.

FIG. 6 illustrates an example controlling component 228.

As shown in the figure, controlling component 228 includes a vehicle determining component 602 and a mode determining component 604.

In this example, vehicle determining component 602 and mode determining component 604 are illustrated as individual devices. However, in some embodiments, vehicle determining component 602 and mode determining component 604 may be combined as a unitary device. Further, in some embodiments, at least one of vehicle determining component 602 and mode determining component 694 may be implemented as a computer having tangible computer-readable media for carrying or having computer-executable instructions or data structures stored thereon.

Vehicle determining component 602 may be any device or system that is able to determine whether device 202 is in a predetermined vehicle. Mode determining component 604 may be any device or system that is able to determine whether device 202 is in a vehicle mode.

One non-limiting example of vehicle determining component 602 being able to register the current vehicle includes the situation when a user instructs device 202 to register the current vehicle by way of input component 214. For example, a user may activate an icon on the GUI to indicate that device 202 is now in a vehicle. Such activation of the GUI would inform vehicle determining component 602 that device 202 is in a predetermined vehicle.

Another non-limiting example of vehicle determining component 602 being able to register the current vehicle includes detecting a field by way of field-detecting component 212. For example, returning to FIG. 2, field-detecting component 212 detects field 206. For purposes of discussion, let field 206 be a magnetic field corresponding to the superposition of magnetic fields generated by all electronic and mechanical systems involved with the running vehicle. A detected field signature may be compared with a priori field signature by any known manner, a non-limiting example of which includes that as described in U.S. patent application Ser. No. 14/072,231

Another non-limiting example of vehicle determining component 602 being able to register the current vehicle includes detecting other parameters by way of parameter-detecting component 222. These other detected parameters may be used to generate a vehicle signature, which in turn will be compared with a priori vehicle signatures by any known manner, a non-limiting example of which includes that as described in U.S. patent application Ser. No. 14/072,231.

In some embodiments, device 202 has a predetermined number of parameters to detect, wherein controlling component 228 may control such detections. For example, the first parameter to be detected may be a magnetic field associated, with a running vehicle, wherein controlling component 228 may instruct field-detecting component 212 to detect a magnetic field. Further, a second parameter to be detected may be another known detected parameter additionally associated with the running vehicle, e.g., vibrations in the chassis, wherein controlling component 228 may instruct parameter-detecting component 222 to detect the second parameter. Farther parameter-detecting component 222 may be able to detect many parameters.

For example, detected parameters of the current vehicle may be used to generate a vehicle signature associated with the current vehicle. This type of vehicle signature generation may be performed by any known method, a non-limiting example of which is disclosed in U.S. patent application Ser. No. 14/072,231, wherein vehicle determining component 602 may control field-detecting component 212, parameter-detecting component 222, comparing component 218 and input component 214 to generate and store a vehicle signature of the current vehicle into database 204.

At this point, in this example, the vehicle of the user of device 202 is registered. As such, device 202 will now automatically recognize when it is in the vehicle of the user of device 202.

Returning to FIG. 5, now that the current vehicle is registered (S506 then returns to S504), it is determined whether the vehicle mode is registered (S508). For example, returning to FIG. 2, controlling component 228 may determine whether the vehicle mode is registered. In some embodiments, device 202 may have specific preset modes, such as a vehicle mode, a sleep mode, a low power mode, a specific location mode, etc., wherein each mode is associated with a respective location.

Returning to FIG. 5, if it is determined that the vehicle mode is not registered (N at S508), then the mode is registered (S510). For example, returning to FIG. 2, controlling component 228 may register the vehicle mode. In some embodiments, device 202 may enable a user to establish modes, such as a vehicle mode, a sleep mode, a low power mode, a specific location mode, etc. In an example embodiment, the user may use the GUI to establish a mode by assigning a vehicle mode to the current vehicle.

In this manner, in some embodiments, controller may instruct input component 214 to input the relationships between registered vehicles and registered modes into database 204. These relationships may be stored in any known method, a non-limiting example of which includes a lookup table. When the determined vehicle corresponds to a previously registered vehicle, and the determined vehicle coincides with the determined vehicle mode, which corresponds to a previously registered vehicle mode, then device 202 may automatically detect an improper state of a tire.

Returning to FIG. 5, in this example embodiment, the vehicle mode is registered (S510) after the vehicle is registered (S504). However, in some embodiments, the mode may be registered prior to the vehicle being registered. Further, in some embodiments, the mode may be registered concurrently with the vehicle being registered.

After the mode is registered (S510), in this example, a parameter is detected (S512) in order to register a signature for an improper state of a tire—an improper tire state signature. For example, returning to FIG. 2, let the parameter be sound. This is a non-limiting example, wherein the detected parameter may be any known detectable parameter, of which other non-limiting examples include electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof.

Returning to FIG. 5, after the first parameter is detected (S512), it is determined whether another parameter is to be detected (S514). For example, returning to FIG. 2, controlling component 228 may instruct at least one of field-detecting component 212 and parameter-detecting component 222 to detect another parameter.

Sound may be a relatively distinct parameter that may be used to determine whether a vehicle has a tire with an improper state. However, there may be situations that elicit a false positive. As such, in order to reduce the probability of a false positive indication that a vehicle has a tire with an improper state, a second parameter associated with an improper state of a tire may be used. Along this notion, it is an example aspect of the invention to detect a plurality of parameters associated with an improper state of a tire to increase the probability of a correct identification of the improper state of a tire.

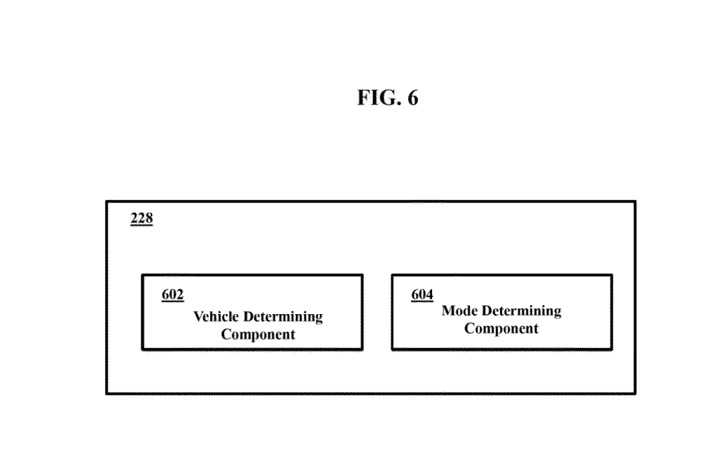

In some embodiments, device 202 has a predetermined number of parameters to detect, wherein controlling component 228 may control such detections. For example, the first parameter to be detected (in S512) may be sound, wherein controlling component 228 may instruct parameter-detecting component 222 to detect sound. Further, a second parameter to be detected may be another known detected parameter additionally associated with a vehicle having a tire with an improper state, e.g., a drastic rhythmic change in vibration, wherein controlling component 228 may instruct parameter-detecting component 222 to detect the second parameter. Further parameter-detecting component 222 may be able to detect many parameters. This will be described with greater detail with reference to FIG. 7.

FIG. 7 illustrates an example parameter-detecting component 222.

As shown in the figure, parameter-detecting component 222 includes a plurality of detecting components, a sample of which are indicated as a first detecting component 702, a second detecting component 704, a third detecting component 706 and an n-th detecting component 708. Parameter-detecting component 222 additionally includes a controlling component 710.

In this example, detecting component 702, detecting component 704, detecting component 706, detecting component 708 and controlling component 710 are illustrated as individual devices. However, in some embodiments, at least two of detecting component 702, detecting component 704, detecting component 706, detecting component 708 and controlling component 710 may be combined as a unitary device. Further, in some embodiments, at least one of detecting component 702, detecting component 704, detecting component 706, detecting component 708 and controlling component 710 may be implemented as a computer having tangible computer-readable media for carrying or having computer-executable instructions or data structures stored thereon.

Controlling component 710 is configured to communicate with: detecting component 702 via a communication line 712; detecting component 704 via a communication line 714; detecting component 706 via a communication line 716; and detecting component 708 via a communication line 718. Controlling component 710 is operable to control each of detecting component 702, detecting component 704, detecting component 706 and detecting component 708. Controlling component 710 is additionally configured to communicate with controlling component 228 of FIG. 2 via communication line 240 and to communicate with field-detecting component 212 of FIG. 2 via communication line 270.

The detecting components may each be a known detecting component that is able to detect a known parameter. For example each detecting component may be a known type of detector that is able to detect at least one of magnetic fields, electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, a change in electric fields, a change in magnetic fields, a change in electro-magnetic fields, a change in velocity, a change in acceleration, a change in angular velocity, a change in angular acceleration, a change in geodetic position, a change in sound, a change in temperature, a change in light, a change in vibrations, a change in pressure, a change in biometrics, a change in contents of surrounding atmosphere and combinations thereof For purposes of discussion, let: detecting component 702 be able to detect sound; detecting component 704 be able to detect velocity in three dimensions; detecting component 706 be able to detect vibrations; and detecting component 708 be able to detect geodetic position.

In some non-limiting example embodiments, at least one of the detecting components of parameter-detecting component 222 may detect a respective parameter as an amplitude at an instant of time. In some non-limiting example embodiments, at least one of the detecting components of parameter-detecting component 222 may detect a respective parameter as a function over a period of time.

Each of the detecting components of parameter-detecting component 222 is able to generate a respective detected signal based on the detected parameter. Each of these detected signals may be provided to controlling component 710 via a respective communication line.

Controlling component 710 is able to be controlled by controlling component 228 via communication line 240.

Returning to FIG. 5, if another parameter is to be detected (Y at S514), then another parameter will be detected (S512). For example, as shown in FIG. 2, controlling component 228 may then instruct parameter-detecting component 222 to detect another parameter via communication line 240. For purposes of discussion, let the second parameter to be detected be acceleration. As such, at this point, as shown in FIG. 7, controlling component 710 instructs detecting component 702, via communication line 712, to detect acceleration. Detecting component 702 provides a signal corresponding to the detected acceleration to controlling component 710 via communication line 712.

This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive identification of an improper state of a tire.

Retuning to FIG. 7, as just discussed, controlling component 710 is able to send individual detected signals from each detecting component. In other example embodiments, controlling component 710 is able to receive and hold the individual detected signals from each detecting component, wherein controlling component 710 is able to generate a composite detected signal that is based on the individual detected signals. The composite detected signal may be based on any of the individual detected signal, and combinations thereof. In some embodiments, controlling component 710 may additionally process any of the individual detected signals and combinations thereof to generate the composite detected signal. Non-limiting examples of further processes include averaging, adding, subtracting, and transforming any of the individual detected signals and combinations thereof.

It should be further noted that in some embodiments, all parameters that are to be detected are detected simultaneously. In such a case, for example, as shown in FIG. 2, controlling component 228 may then instruct parameter-detecting component 222 to detect all parameters via communication line 240. As such, at this point, as shown in FIG. 7. controlling component 710 instructs an the detecting components to detect their respective parameters. All the detecting components then provide a respective signal corresponding to the respective detected parameter to controlling component 710 via communication line 714. In this example, controlling component 710 may then provide the detected signal to field-detecting component 212 via communication line 270 as shown in FIG. 2.

Returning to FIG. 5, if no more parameters are to be detected (N at S514), then an improper tire state signature is generated (S516). For example as shown in FIG. 2, parameter-detecting component 222 may generate an improper tire state signature of the improper tire state based on the detected parameter.

Returning to FIG. 5, once the improper tire state signature is generated (S516), the improper tire state signature in input into memory (S518). For example, as shown in FIG. 2, field-detecting component 212 provides the signature to input component 214 via communication line 246.

In an example embodiment, input component 214 includes a GUI that informs a user of device 202 that an improper tire state signature has been generated. Input component 214 may additionally enable the user to input an association between the registered vehicle, the registered mode and the generated improper tire state signature. For example, input component 214 may display on a GUI a message such as “A signature was generated. To what improper tire state is the signature associated?” Input component 214 may then display an input prompt for the user to input, via the GUI., an improper tire state to be associated with the generated improper tire state signature.

In another example embodiment, input component 214 includes a GUI that informs a user of device 202 that an improper tire state signature has been generated. Input component 214 may additionally enable the user to verify that there is an actual improper tire state. For example, suppose a vehicle encounters a large pothole thus creating a loud noise and a sudden jerking motion of the vehicle, both of which are recorded by device 202. Further, device 202 generates an improper tire state signature with the loud noise and the sudden jerking motion of the vehicle, even though in this case the tire did not blow out. In such situations, the user of device 202 may indicate, via input, component 214, that there is no improper tire state, wherein a non-improper tire state signature may be generated. These non-improper tire state signatures may be used to actively reduce the likelihood of future false positive identifications of an improper tire state.

Input component 214 may then provide the improper tire state signature, and the association to a specific vehicle and mode, to database 204 via communication line 250.

As discussed above, in some embodiments, database 204 is part of device 202, whereas in other embodiments, database 204 is separate from device 202. Data input and retrieval from database 204 may be faster when database 204 part of device 202, as opposed to cases where database 204 is distinct from device 202. However, size may be a concern when designing device 202, particularly when device 202 is intended to be a handheld device such as a smartphone. As such, device 202 may be much smaller when database 204 is distinct from device 202, as opposed to cases where database 204 is part of device 202.

Consider an example embodiment, where database 204 is part of device 202. In such cases, input component 214 may enable a user to input improper tire state signatures and the vehicle/mode associations, for a predetermined number of improper tire states. In this manner, database 204 will only be used for device 202.

Now consider an example embodiment, where database 204 is separate from device 202. Further, let database 204 be much larger than the case where database 204 is part of device 202. Still further, let database 204 be accessible to other devices in accordance with aspects of the present invention. In such cases, input component 214 may enable a user to input improper tire state signatures and the vehicle/mode associations, for a much larger predetermined number of improper tire states. Further, in such cases, input component 214 may enable other users of similar devices to input improper tire state signatures and the vehicle/mode associations, for even more improper tire states.

It should be noted that although the above-discussed example includes identifying an improper tire state, this is a non-limiting example. Aspects of the invention may additionally be used to identify any improper state of a vehicle. For example, if a vehicle needs an alignment, the chassis may vibrate in an unwanted and detectable manner, which may have an unwanted chassis signature. In another non-limiting example, a timing belt may cause the engine to fire inappropriately, thus causing the vehicle to jump and stutter, which may lead to an unwanted engine operation signature.

At this point, method 500 stops (S520).

A vehicle, a mode of operation at the registered vehicle, and an improper tire state have been registered. In accordance with aspects of the present invention, device 202 will be able to subsequently automatically determine when it is in the registered mode at the registered vehicle. When device 202 automatically determines such situations, device 202 will automatically modify its operation based on a detected improper tire state.

With a prior art system or method, a user may have to actuate to device to modify its operation when the user determines that he is in particular vehicle and the phone is operating in a vehicle mode. On the contrary, in accordance with aspects of the present invention, device 202 will automatically modify its operation without any user involvement.

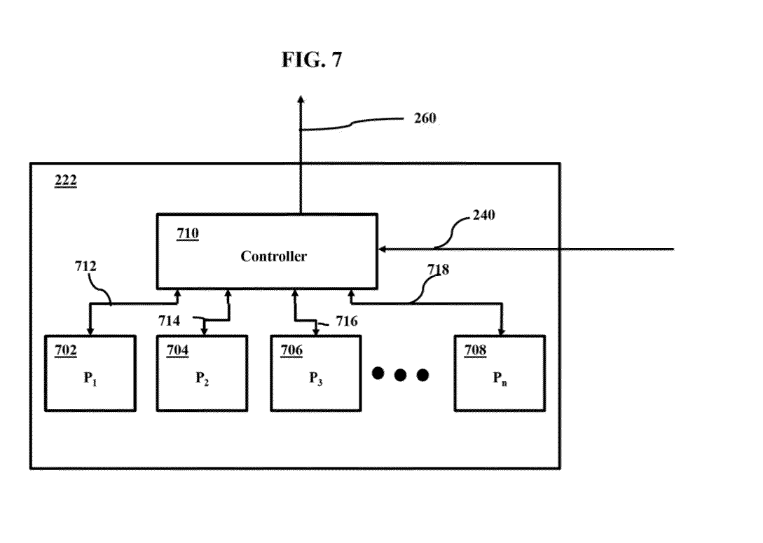

Returning to FIG. 1, now that a vehicle, a vehicle mode and an improper tire state have been registered (S104), a future improper tire state may be detected (S106). In other words, now that a vehicle has been registered, and now that a mode of operation of device 202, within the vehicle, has been registered, device 202 will detect whether it is in the registered vehicle while operating in the vehicle mode and a predetermined improper tire state is detected. This will further described with additional reference to FIG. 8.

FIG. 8 illustrates a method 800 for detecting an improper tire state when in a registered vehicle while operating in a registered mode.

As shown in the figure, method 800 starts (S802) and it is determined whether the current vehicle is a registered vehicle (S804). The current vehicle may be detected by any known system or method. In an example embodiment, the vehicle is detected in a manner as disclosed in U.S. patent application Ser. No. 14/105,934.

For example, returning to FIG. 8, a plurality of parameters ma be detected via field detecting component 212 and parameter-detecting component 222. The detected parameters may be used to generate a vehicle signature of the current vehicle. The generated vehicle signature is then compared with previously stored vehicle signatures associated with previously registered vehicles, as stored in database 204. When the generated vehicle signature coincides with a previously stored vehicle signature associated with previously registered vehicle, identifying portion 220 identifies the current vehicle as one of the previously registered vehicles.

If device 202 is not in a registered vehicle (N at S804), then method 800 continues until it is determined that device 202 is in a registered vehicle (Y at S804).

Returning to FIG. 8, after determining that the current vehicle is a registered vehicle (V at S804), it is determined whether the current mode of operation is a registered vehicle mode corresponding to the registered vehicle (S806). The current mode may be detected in a manner similar to that discussed above with reference to FIG. 5 (S508). In particular, for example, returning to FIG. 8, controlling component 228 may determine whether the current mode is registered.

If device 202 is not in a registered mode corresponding to the registered vehicle (N at S806), then method 800 continues until it is determined that device 202 is in the corresponding registered mode (Y at S804).

After determining that the current mode is the corresponding registered mode (Y at S806), a new signature is generated (S808). Consider, for example, the tire blow-out discussed above with reference to FIGS. 3A-C. In accordance with aspects of the present invention, device 202 may detect parameters associated with previously registered improper tire state. These detected parameters are used to generate new improper tire state signatures.

For example, the sound associated with the blow-out of tire 302 as shown in FIG. 3B and the subsequent vibrations and noise as shown in FIG. 3C may be detected, this indicating a flat tire.

By analyzing at least one detected parameter associated with device 202, it may be determined whether or not tire 302 is in an improper state.

When device 202 is in a registered vehicle and is operating in a registered mode corresponding to the registered vehicle and a specific improper tire state is detected, a warning of an improper state may be generated. Non-limiting examples of such warnings include generating an audible warning to the user of device 202, providing, a visual warning to the user of device 202, sending a communication to another device and combinations thereof.

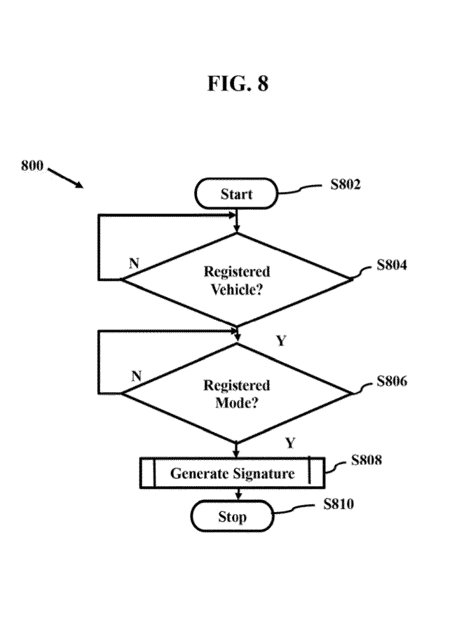

This aspect of the present invention will be further described with reference to FIG. 9.

FIG. 9 illustrates an example method 900 of generating an improper tire state signature in accordance with aspects of the present invention.

As shown in the figure, method 900 starts (S902) and a parameter is detected (S904). A parameter may be detected by any known method or system. In an example embodiment, a parameter is detected in a manner similar to that discussed above with reference to method 900, e.g., S912. Non-limiting examples of detected parameters include at least one of magnetic fields, electric fields, electro-magnetic fields, velocity, acceleration, angular velocity, angular acceleration, geodetic position, sound, temperature, an image, a Blue Tooth signal, a Wi-Fi signal, light, vibrations, pressure, biometrics, contents of surrounding atmosphere, as change in electric fields, a change in magnetic fields, a change in electro-magnetic fields, a change in velocity, a change in acceleration, a change in angular velocity, as change in angular acceleration, a change in geodetic position, as change in sound, as change in temperature, a change in light, a change in vibrations, a change in pressure, a change in biometrics, a change in contents of surrounding atmosphere and combinations thereof.

Returning to FIG. 9, after the parameter has been detected (S904), it is determined whether more parameters are to be detected (S906). The additional parameters may be detected by any known method or system. In an example embodiment, additional parameters may be detected in a manner similar to that discussed above with reference to method 900, e.g., S914.

Returning to FIG. 9, if another parameter is to be detected (Y at S906), then another parameter will be detected (S904). This process will repeat until all the parameters to be detected are detected. In some embodiments, this process will repeat a predetermined number of times in order to detect predetermined types of parameters. In some embodiments, this process is only repeated until enough parameters are detected in order reach a predetermined probability threshold, which will reduce the probability of a false positive improper tire state determination.

An improper tire state signature is then generated (S908). The improper tire state signature may be generated by any known method or system. In an example embodiment, a signature is generated a manner similar to that discussed above with reference to method 800, e.g., S808.

Returning to FIG. 9, after the improper tire state signature is generated (S908), it is then inputted (S910). As shown in FIG. 2, this second signature is provided to comparing component 218.

Method 900 then stops (S912). Returning to FIG. 8, method 800 additionally stops (S810).

In accordance with aspects of the present invention, method 800 may be performed continuously, or at predetermined intervals. In some embodiments, a predetermined time threshold, tₜₕ is stored, for example in controlling component 218. The time threshold, tₜₕ, may be used to decrease the likelihood of a false positive identification of an improper tire state. This may be accomplished by performing method 800 at a first time, t₁, then subsequently performing method 800 a second time, t₂, wherein the difference between t₁ and t₂ is Δt. If performance of method 800 indicates an improper tire state and if Δt>tₜₕ, then it is determined that there is indeed an improper tire state. In short, if the improper tire state is detected after a long enough period, it is likely to be an accurate detection of an improper tire state.

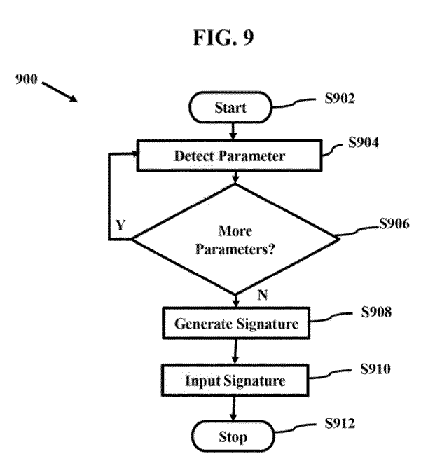

Returning to FIG. 1, after the improper tire state has been detected (S106), it is verified (S108). For example, a device in accordance with aspects of the present invention would determine whether the newly detected improper tire state is the improper tire state that was previously registered. A more detailed discussion of registration will now be provided with additional reference to FIG. 10.

FIG. 10 illustrates an example method 1000 of verifying an improper tire state in accordance with aspects of the present invention.

Method 1000 starts (S1002) and the previously stored improper tire state signature is accessed (S1004). For example, as shown in FIG. 2, access component 216 retrieves the previously-stored improper tire state signature from database 204 via communication line 254. Access component 216 then provides the retrieved, previously-stored improper tire state signature to comparator 218 via communication line 256.

Returning to FIG. 10, now that the previously stored improper tire state signature has been accessed (S1004), the improper tire state signatures are compared (S1006). For example, as shown in FIG. 2, comparator 218 compares the retrieved, previously stored improper tire state signature as provided by access component 216 with the newly generated improper tire state signature as provided by field-detecting component 212.

Returning, to FIG. 10, now that the improper tire state signatures have been compared (S1006), the improper tire slate may be identified (S1008). For example, as shown in FIG. 2, comparator 218 provides an output to identifying component 220 via communication line 258 if the retrieved, previously stored improper tire state signature as provided by access component 216 matches the newly generated improper tire state signature as provided by field-detecting component 212, then the newly detected improper tire state is the same improper tire state that was previously registered. In such a case, identifying component 220 may indicate that the newly detected improper tire state is the same improper tire state that was previously registered. If the retrieved, previously stored improper tire state signature as provided by access component 216 does not match the newly generated improper tire state signature as provided by field-detecting component 212, then the newly detected improper tire state is not the same improper tire state that was previously registered. In such a case, identifying component 220 may indicate that the newly detected improper tire state is not the same improper tire state that was previously registered.

It should be noted that in some embodiments, the comparison of the signatures (S1006) may include comparison of non-improper tire state signatures. As mentioned previously, there may be non-improper tire state signatures stored in database 204. These signatures may be used to actively exclude newly generated signatures, thus preventing a false positive identification of an improper tire state. For example, a previously stored signature corresponding to the loud noise and sudden jarring of a vehicle as it encounters a pothole, without blowing out the tire, may be used to correctly identify a similar occurrence.

At this point, method 1000 stops (S1010).

Returning to FIG. 7, after the improper tire state has been verified, the data is updated (S110). For example, in some embodiments, as shown in FIG. 2, comparator 218 may determine that the previously stored improper tire state signature as provided by access component 216 does not exactly match the newly generated improper tire state signature as provided by field-detecting component 212, but the difference between the previously stored improper tire state signature as provided by access component 216 does not exactly match the newly generated improper tire state signature as provided by field-detecting component 212 is within a predetermined acceptable limit. In such cases, identifying component 220 may indicate that the newly detected improper tire state is still the same improper tire state that was previously registered. Further, comparator 218 may provide the newly generated improper tire state signature as provided by field-detecting component 212 to access component 216 via communication line 256. Access component 216 may then provide the newly generated improper tire state signature to database 204 via communication line 254.

In this manner, database 204 may be “taught” to accept variations of previously registered improper tire state signatures. In some embodiments, an average of recognized improper tire state signatures may be stored for future use. In some embodiments, a plurality of each recognized improper tire state signature may be stored for future use.

Returning to FIG. 7, after updating (S110) device 202 waits to detect a new improper tire state (S106) and method 100 continues.

The example embodiments discussed above are drawn to identifying, via a communication device, a vehicle using fields and other parameters associated therewith. Once in an identified vehicle, and in a vehicle mode, the communication device may automatically detect an improper state of a tire. A further aspect includes providing a warning once the improper state of the tire is detected.

In the drawings and specification, there have been disclosed embodiments of the invention and, although specific terms are employed, they are used in a generic and descriptive sense only and not for purposes of limitation, the scope of the invention being set forth in the following claims.

What is claimed as new and desired to be protected by Letters Patent of the United States is:

1. A device for use with a database, having stored therein, a plurality of signatures corresponding to an improper state of a tire, respectively, said device comprising:
a vehicle mode determining component operable to determine whether the device is operating in as vehicle mode;
a parameter detecting component operable to detect a predetermined parameter associated with the improper state of a tire and to generate a parameter signature based on the detected predetermined parameter;
an accessing component operable to access one of the plurality of signatures from the database;
a comparing component operable to generate a comparison signal based on a comparison of the parameter signature and one of the plurality of signatures; and
a warning component operable to generate an improper tire signal based on the comparison signal when said vehicle mode determining component determines that the device is operating in the vehicle mode.

2. The device of claim 1, further comprising:
a timing component operable to have a time threshold stored therein,
wherein said parameter detecting component is operable to detect the predetermined parameter associated with the improper state of as tire at a first time and a second time, and
wherein said parameter detecting component is operable to generate the parameter signature when the difference between the first time and the second time is less than the time threshold.

3. The device of claim 2, wherein said parameter detecting component comprises a detecting component operable to detect at least one of a magnetic field, velocity, acceleration, angular velocity, angular acceleration, geodetic position, sound, vibrations, pressure, a change in magnetic field, a change in acceleration, a change in angular acceleration, a change in geodetic position, a change in sound, a change in vibrations, a change in pressure and combinations thereof.

4. The device of claim 3, further comprising:
a contact storage component having contact information stored therein; and
a transmitting component operable to transmit a warning signal, based on the improper tire signal, to a second device associated with the contact information.

5. The device of claim 1, wherein said parameter detecting component is further operable to provide the parameter signature to the database.

6. The device of claim 1, wherein said parameter detecting component operable to detect a second predetermined parameter associated with the improper state of a tire and to generate the parameter signature based on the detected predetermined parameter associated with the improper state of a tire and the detected second predetermined parameter associated with the improper state of a tire.

7. The device of claim 1, further comprising:
a contact storage component having contact information stored therein; and
a transmitting component operable to transmit a warning signal, based on the improper tire signal, to a second device associated with the contact information.

8. A method of using a device with a database, having stored therein, a plurality of signatures corresponding to an improper state of a tire, respectively, said method comprising:
determining, via vehicle mode determining component, whether the device is operating in a vehicle mode;
detecting, via a parameter detecting component, a predetermined parameter associated with the improper state of a tire;
generating, via the parameter detecting component, a parameter signature based on the detected predetermined parameter;
accessing, via an accessing component, one of the plurality of signatures from the database;
generating via a comparing, component, a comparison signal based on a comparison of the parameter signature and one of the plurality of signatures; and
generating, via a warning component, an improper tire signal based on the comparison signal when the vehicle mode determining component determines that the device is operating in the vehicle mode.

9. The method of claim 8, further comprising:
storing, via a timing component, a time threshold,
wherein said detecting, via a parameter detecting component, a predetermined parameter associated with the improper state of a tire comprises detecting the predetermined parameter associated with the improper state of a tire at a first time and a second time, and
wherein said generating, via the parameter detecting component, a parameter signature based on the detected predetermined parameter comprises generating the parameter signature when the difference between the first time and the second time is less than the time threshold.

10. The method of claim 9, wherein said detecting, via a parameter detecting component, a predetermined parameter associated with the improper state of a tire comprises detecting the predetermined parameter as at least one of a magnetic field, velocity, acceleration, angular velocity, angular acceleration, geodetic position, sound, vibrations, pressure, a change in magnetic field, a change in acceleration, a change in angular acceleration, a change in geodetic position, a change in sound, a change in vibrations, a change in pressure and combinations thereof.

11. The method of claim 10, further comprising:
storing, via a contact storage component, contact information; and
transmitting, via a transmitting component, a warning signal, based on the improper tire signal, to a second device associated with the contact information.

12. The method of claim 8, further comprising providing, via the parameter detecting component, the parameter signature to the database.

13. The method of claim 8, further comprising:
detecting, via the parameter detecting component, a second predetermined parameter associated with the improper state of a tire.
wherein said generating, via the parameter detecting component, a parameter signature based on the detected predetermined parameter comprises generating the parameter signature based on the detected predetermined parameter associated with the improper state of a tire and the detected second predetermined parameter associated with the improper state of a tire.

14. The method of claim 8, further comprising:
storing, via a contact storage component, contact information; and
transmitting, via a transmitting component, a warning signal, based on the improper tire signal, to a second device associated with the contact information.

15. A non-transitory, tangible, computer-readable media having computer-readable instructions stored thereon, for use with a database, having stored therein, a plurality of signatures corresponding to an improper state of a tire, respectively, the computer-readable instructions being capable of being read by a computer and being capable of instructing the computer to perform the method comprising:
determining, via vehicle mode determining component, whether the device is operating in a vehicle mode;
detecting, via a parameter detecting component, a predetermined parameter associated with the improper state of a tire;
generating, via the parameter detecting component, a parameter signature based on the detected predetermined parameter;
accessing, via an accessing component, one of the plurality of signatures from the database;
generating, via a comparing component, a comparison signal based on a comparison of the parameter signature and one of the plurality of signatures; and
generating, via a warning component, an improper tire signal based on the comparison signal when the vehicle mode determining component determines that the device is operating in the vehicle mode.

16. The non-transitory, tangible, computer-readable media of claim 15, the computer-readable instructions being capable of being read by a computer and being capable of instructing the computer to perform the method further comprising:
storing, via a timing component, a time threshold,
wherein said detecting, via a parameter detecting component, a predetermined parameter associated with the improper state of a tire comprises detecting the predetermined parameter associated with the improper state of a tire at a first time and a second time, and
wherein said generating, via the parameter detecting component, a parameter signature based on the detected predetermined parameter comprises generating the parameter signature when the difference between the first time and the second time is less than the time threshold.

17. The non-transitory, tangible, computer-readable media of claim 16, wherein the computer-readable instructions are capable of instructing the computer to perform the method such that wherein said detecting, via a parameter detecting component, a predetermined parameter associated with the improper state of a tire comprises detecting the predetermined parameter as at least one of a magnetic field, velocity, acceleration, angular velocity, angular acceleration, geodetic position, sound, vibrations, pressure, a change in magnetic field, a change in acceleration, a change in angular acceleration, a change in geodetic position, a change in sound, a change in vibrations, a change in pressure and combinations thereof.

18. The non-transitory, tangible, computer-readable media of claim 17, the computer-readable instructions being capable of being read by a computer and being capable of instructing the computer to perform the method further comprising:
storing, via a contact storage component, contact information; and
transmitting, via a transmitting component, a warning signal, based on the improper tire signal, to a second device associated with the contact information.

19. The non-transitory, tangible, computer-readable media of claim 15, the computer-readable instructions being capable of being read by a computer and being capable of instructing the computer to perform the method further comprising providing, via the parameter detecting component, the parameter signature to the database.

20. The non-transitory, tangible, computer-readable media of claim 15, the computer-readable instructions being capable of being read by a computer and being capable of instructing the computer to perform the method further comprising:
detecting, via the parameter detecting component, a second predetermined parameter associated with the improper state of a tire,
wherein said generating, via the parameter detecting component, a parameter signature based on the detected predetermined parameter comprises generating the parameter signature based on the detected predetermined parameter associated with the improper state of a tire and the detected second predetermined parameter associated with the improper state of a tire.
